(19) United States
(12) Patent Application Publication
(10) Pub. No.: US 2015/0175736 A1
(43) Pub. Date: Jun. 25, 2015

(54) STABLE THERMOPLASTIC POLYURETHANE ELASTOMERS

(71) Applicant: Ticona LLC, Florence, KY (US)

(72) Inventors: Sung Hye Kim, Erlanger, KY (US); Lowell Larson, Independence, KY (US)

(21) Appl. No.: 14/526,689

(22) Filed: Oct. 29, 2014

Related U.S. Application Data
(60) Provisional application No. 61/919,539, filed on Dec. 20, 2013.

(51) Int. Cl. C08G 18/20; C08K 5/3475; C08G 18/73; C08G 18/48; C08G 18/42; C08G 18/32

(52) U.S. Cl. CPC C08G 18/2081; C08G 18/42; C08G 18/3206; C08G 18/73; C08G 18/48; C08K 5/3475

(57) ABSTRACT

A process for producing thermoplastic elastomers, particularly thermoplastic polyurethane elastomers, is described. The thermoplastic polyurethane elastomer is produced using a pyridine derivative, such as 4-morpholinopyridine.

### RELATED APPLICATIONS

The present application is based upon and claims priority to U.S. Provisional Patent Application No. 61/919,539 which was filed on Dec. 20, 2013, which is incorporated herein by reference.

### BACKGROUND

Thermoplastic polyurethanes (“TPUs”) are partially crystalline materials and belong to the class of thermoplastic elastomers. A characteristic of polyurethane elastomers is the segmented structure of the macromolecules. Owing to the differing cohesion energy densities of these segments, a phase separation into crystalline “hard” and amorphous “soft” regions occurs in most applications. The resulting two-phase structure determines the property profile of TPUs. Thermoplastic polyurethanes are plastics having a wide range of applications. Thus, TPUs are used, for example, in the automobile industry, e.g. in dashboard skins, in films, in cable sheathing, in the leisure industry, as deposition areas, as functional and design elements in sports shoes, as flexible components in rigid-flexible combinations and in many further applications.

Thermoplastic polyurethanes can be used alone to produce various articles or may be blended with other polymers. For example, thermoplastic polyurethanes can be blended with more rigid polymers to produce articles having enhanced impact strength resistance. For example, in one embodiment, thermoplastic polyurethanes are combined with polyoxymethylene polymers in producing various molded articles, such as gasoline tanks.

Thermoplastic polyurethanes can also be subject to various different cross-linking processes. The polymer, for instance, can be cross-linked through the addition of isocyanates to the thermoplastic polyurethane in a molten state.

Thermoplastic polyurethanes are typically produced by reacting together in organic diisocyanate, polyhydroxyl compounds having molecular weights of greater than about 400, one or more chain extenders, and a catalyst. In order to produce thermoplastic polyurethanes having stable properties, the above components should be permitted to fully react prior to use of the polymer. For instance, if the components are not fully reacted, the melt flow rate and/or various other properties may have a tendency to fluctuate after the polymer is produced for a finite period of time. In view of the above, a need exists for a process for producing thermoplastic polyurethanes wherein the reaction kinetics are accelerated.

### SUMMARY

In general, the present disclosure is directed to a process for producing thermoplastic polyurethanes and to thermoplastic polyurethanes produced from the process. In accordance with the present disclosure, a particular catalyst is chosen that produces desirable reaction kinetics during production of the polymer. In one embodiment, for instance, the catalyst may accelerate the reaction kinetics in comparison to some catalysts used in the past. As will be described in greater detail below, thermoplastic polyurethanes made in accordance with the present disclosure are extremely stable. In addition, the catalyst does not drive the reaction to unfavorable side reactions or produces unfavorable reverse reactions.

In one embodiment, the present disclosure is directed to a process for producing a thermoplastic polyurethane. The process includes the steps of reacting at least one organic diisocyanate with at least one polyhydroxyl compound and with at least one chain extender in the presence of a catalyst. In accordance with the present disclosure, the catalyst comprises a pyridine derivative. For instance, the pyridine derivative may comprise 4-morpholinopyridine. The thermoplastic polyurethane produced can be polyester based, polyether based, and/or aliphatic-based. When producing an aliphatic-based thermoplastic polyurethane, the organic diisocyanate may comprise an aliphatic diisocyanate.

The at least one polyhydroxyl compound, in one embodiment, can have a molecular weight of from about 500 to about 15,000, such as from about 500 to about 11,500. As used herein, molecular weights refer to the number average molecular weight of the compound or polymer. The polyhydroxyl compound may comprise a polyoxyalkylene polyether polyol or a polyester polyol.

The chain extender may generally have a molecular weight of from about 50 to about 450. In one embodiment, the chain extender comprises 1,4-butanediol. The molar ratio between all of the polyhydroxyl compounds and all of the chain extenders can be from about 1:1 to about 1:8.

The resulting thermoplastic polyurethane, in one embodiment, can have a Shore A hardness of from about 70 to about 94, such as from about 70 to about 89. The thermoplastic polyurethane may be combined with various different additives, such as a flame retardant and/or a light stabilizer. In one embodiment, the process can further include the step of cross linking the thermoplastic polyurethane. For instance, in one embodiment, the thermoplastic polyurethane maybe combined with a second isocyanate compound and cross linked.

The present disclosure is also directed to a thermoplastic polyurethane elastomer. The thermoplastic polyurethane elastomer can have a Shore A hardness of from about 70 to about 94 and can contain 4-morpholinopyridine. In one embodiment, the thermoplastic polyurethane elastomer may be combined with a light stabilizer package comprising at least one hindered amine light stabilizer and a benzotriazole.

Other features and aspects of the present disclosure are discussed in greater detail below.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a process for producing a thermoplastic polyurethane elastomer and to the thermoplastic polyurethane elastomer produced by the process. In accordance with the present disclosure, the thermoplastic polyurethane elastomer is produced in the presence of a catalyst that, in one embodiment, comprises 4-morpholinopyridine. In fact, in one embodiment, 4-morpholinopyridine may be the only catalyst used during the process.

The use of the above described catalyst can provide various benefits and advantages. For instance, the catalyst may optimize the reaction kinetics during production of the thermoplastic polyurethane elastomer. For instance, the catalyst may drive the reaction to completion faster producing an elastomer with stable properties. In particular, thermoplastic polyurethane elastomers may according to the present disclosure may not experience physical property fluctuations after being formed such as within the first days or weeks of production. For example, it is believed that the use of the catalyst will produce a thermoplastic polyurethane elastomer that has a stable melt flow viscosity that does not fluctuate over time. In this manner, the thermoplastic polyurethane elastomer can be produced and used immediately in different thermoplastic molding processes. In one embodiment, the melt volume rate or melt index of the elastomer can be determined according to ISO Test 1133 at 190° C. and at a load of 2.16 kg. Thermoplastic polyurethane elastomers made according to the present disclosure may be produced having a melt flow rate that does not fluctuate by more than 30%, such as by more than 20%, such as by more than 10%, such as more than 5%, such as even more than 3% within the first 24 hours after production of the polymer.

In addition to producing polymers with stable properties, the catalyst of the present disclosure is also relatively easy and safe to handle in comparison to catalysts used in the past. For instance, 4-morpholinopyridine is non-flammable and has a relatively low health hazard rating.

In general, the catalyst is a pyridine derivative. In particular, the pyridine derivative has a 4-N-substituted pyridine ring. As stated above, in one embodiment, the catalyst comprises 4-morpholinopyridine. In producing the thermoplastic polyurethane elastomer, the catalyst can be present in the reaction mixture in relatively low amounts. For instance, the catalyst can be present in an amount less than about 2% by weight, such as in an amount less than about 1% by weight. For example, the catalyst can be present in the reaction mixture in an amount from about 0.001% to about 1% by weight, such as from about 0.05% to about 0.5% by weight.

The thermoplastic polyurethane elastomer made in accordance with the present disclosure can be polyether-based or polyester-based. In one embodiment, the thermoplastic polyurethane elastomer can be made from aliphatic components and therefore may be aliphatic-based. Thermoplastic polyurethane elastomers made according to the present disclosure generally have a Shore hardness of from about 70A to about 60D. The Shore hardness of the elastomer can generally be greater than about 72A, such as greater than about 74A, such as greater than about 76A. The Shore hardness is generally less than about 96A, such as less than about 94A, such as less than about 92A, such as less than about 90A.

Processes for producing TPU are generally known. For example, the thermoplastic polyurethanes can be produced by reacting (a) isocyanates with (b) compounds which are reactive toward isocyanates and have a molecular weight of from 450 to 12,000 and, if appropriate, (c) chain extenders having a molecular weight of from 50 to 450, if appropriate in the presence of (d) a catalyst in accordance with the present disclosure.

The starting components and processes for producing the preferred TPUs are presented below by way of example. The components (a), (b), (c), (d), and if appropriate, auxiliaries (e) that may be used in the production of TPUs are described by way of example below:

a) As organic isocyanates (a), it is possible to use generally known aromatic, aliphatic, cycloaliphatic and/or araliphatic isocyanates, preferably diisocyanates, for example diphenylmethane 2,2′-, 2,4′- and/or 4,4′-diisocyanate (MDI), naphthylene 1,5-diisocyanate (NDI), tolylene 2,4- and/or 2,6-diisocyanate (TDI), diphenylmethane diisocyanate, 3,3′-dimethylbiphenyl diisocyanate, 1,2-diphenyl-ethane diisocyanate and/or phenylene diisocyanate, trimethylene, tetramethylene, pentamethylene, hexamethylene, heptamethylene and/or octamethylene diisocyanate, 2-methylpentarnethylene 1,5-diisocyanate, 2-ethyl-butylene 1,4-diisocyanate, pentamethylene 1,5-diisocyanate, butylene 1,4-diisocyanate, 1-isocyanate-3,3,5-trimethyl-5-isocyanatomethylcyclohexane (isophorone diisocyanate, IPDI), 1,4- and/or 1,3-bis(isocyanatomethyl)-cyclohexane (HXDI), cyclohexane 1,4-diisocyanate, 1-methylcyclohexane 2,4- and/or -2,6-diisocyanate and/or dicyclohexylmethane 4,4′-, and 2,2′-diisocyanate, preferably diphenylmethane 2,2′-, 2,4′- and/or 4,4′-diisocyanate (MDI), naphthylene 1,5-diisocyanate (NDI), tolylene 2,4- and/or 2,6-diisocyanate (TDI), hexamethylene diisocyanate and/or IPDI, in particular 4,4′-MDI and/or hexamethylene diisocyanate.

b) As compounds (b) which are reactive toward isocyanates, it is possible to use generally known compounds which are reactive toward isocyanates, for example polyesterols, polyetherols and/or polycarbonatediols, which are usually collectively referred to as “polyols” or polyhydroxyl compounds, having molecular weights of from 500 to 14,000 g/mol, preferably from 500 to 6500 g/mol, in particular from 800 to 4000 g/mol, and preferably a mean functionality of from 1.8 to 2.3, preferably from 1.9 to 2.2, in particular 2.

Examples of higher molecular polyhydroxyl compounds with molecular weights of 500 to 8,000 are polyoxyalkylene polyether polyols, and particularly polyester polyols. However, other suitable hydroxyl group-containing polymers include polyacetals such as polyoxymethylenes and primarily water-insoluble formals such as polybutanediol formal and polyhexanediol formal and polycarbonates, particularly those prepared from diphenylcarbonate and 1,6-hexanediol by transesterification. The polyhydroxyl compounds must be at least predominantly linear, that is, they must have a difunctional structure. The cited polyhydroxyl compounds may be used individually or as mixtures.

Suitable polyoxyalkylene polyether polyols may be prepared by reacting one or more alkylene oxides with 2 to 4 carbon atoms in the alkylene radical with an initiator molecule which contains two active hydrogen atoms. Suitable alkylene oxides include ethylene oxide, 1,2-propylene oxide, 1,2- and 2,3-butylene oxide as well as epichlorohydrin. Preferably used are ethylene oxide and mixtures of propylene oxide and ethylene oxide. The alkylene oxides may be used individually, alternatingly in sequence, or as mixtures. Suitable initiator molecules include: water, amino alcohols such as N-alkyldiethanol amines, for example, N-methyldiethanol amine and dials such as ethylene glycol, trimethylene glycol, 1,4-butanediol and 1,6-hexanediol. Optionally, mixtures of initiator molecules may also be used. Other suitable polyether polyols include the hydroxyl group-containing polymerization products of tetrahydrofuran.

Preferably used are hydroxyl group-containing polytetrahydrofuran and polyoxyalkylene polyether polyols of propylene oxide and ethylene oxide where more than 50 percent, preferably 60 to 80 percent of the hydroxyl groups are primary hydroxyl groups, and where at least part of the ethylene oxide is present as a terminal block.

Such polyoxyalkylene polyether polyols may be obtained, for example, by the initial addition of propylene oxide to the starter molecule and then subsequently adding the ethylene oxide, or by the initial addition of the entire amount of propylene oxide mixed with part of the ethylene oxide, and to subsequently add the rest of the ethylene oxide, or by the initial addition of part of

the ethylene oxide to the initiator molecule and followed by the entire amount of propylene oxide, and then the addition of the remainder of the ethylene oxide.

The basically linear polyoxyalkylene polyether polyols have molecular weights from 500 to 8,000, preferably 600 to 6,000, and particularly 800 to 3,500. They may be used individually as well as in the form of mixtures.

Suitable polyester polyols may be prepared, for example, by the reaction of dicarboxylic acids with 2 to 12 carbon atoms and multifunctional alcohols. Suitable dicarboxylic acids include, for example: aliphatic dicarboxylic acids such as succinic acid, glutaric acid, adipic acid, subaric acid, azelaic acid and sebacic acid, and aromatic dicarboxylic acids such as phthalic acid, isophthalic acid and terephthalic acid. The dicarboxylic acids may be used individually or as mixtures, for example in the form of a succinic, glutaric and adipic acid mixture. For the preparation of the polyester polyols it may optionally be advantageous to use transesterification techniques employing acid esters containing from 1 to 4 carbon atoms in the alcohol radical. Carboxylic acid anhydrides or carboxylic acid chlorides may also be employed. Examples of multifunctional alcohols are glycols with 2 to 16 carbon atoms such as ethylene glycol, diethylene glycol, 1,4butanediol, 1,5-pentanediol, 1,6-hexanediol, 1,10-decanediol, 2,2-dimethyl propanediol-1,3, trimethylene glycol and dipropylene glycol. Depending upon the desired properties, the multifunctional alcohols may be used alone or optionally, in mixtures.

Also suited are esters of carbonic acid with the cited dials, particularly those with 4 to 6 carbon atoms, such as 2,4-butanediol and/or 1,6-hexandiol, condensation products of ω-hydroxycarboxylic acids, such as ω-hydroxycapronic acid and preferably polymerization products of lactones, for example, optionally substituted ω-caprolactones.

c) As chain extenders (c), it is possible to use generally known aliphatic, araliphatic, aromatic and/or cycloaliphatic compounds having a molecular weight of from 50 to 450, preferably 2-functional compounds, for example diamines and/or alkane-diols having from 2 to 10 carbon atoms in the alkylene radical, in particular 1,4-butanediol, 1,6-hexanediol, and/or dialkylene, trialkylene, tetraalkylene, pentaalkylene, hexaalkylene, heptaalkylene, octaalkylene, nonaalkylene and/or decaalkylene glycols having from 3 to 8 carbon atoms, preferably corresponding oligopropylene glycols and/or polypropylene glycols, with mixtures of chain extenders also being able to be used.

d) As described above, in accordance with the present disclosure, the catalyst used to improve the reaction kinetics is a pyridine derivative, and particularly a pyridine derivative having a 4-N-substituted pyridine ring. In one embodiment, the catalyst comprises 4-morpholinopyridine.

e) Apart from a catalyst (d), customary auxiliaries (e) can also be added to the formative components (a) to (c). Mention may be made of, for example, surface-active substances, flame retardants, nucleating agents, oxidation stabilizers, lubricants and mold release agents, dyes and pigments, stabilizers, e.g. against hydrolysis, light, heat or discoloration, inorganic and/or organic fillers, reinforcing materials and plasticizers. As hydrolysis inhibitors, preference is given to using oligomeric and/or polymeric aliphatic or aromatic carbodiimides. To stabilize the TPUs of the invention against aging, stabilizers are preferably added to the TPU. Stabilizers for the purposes of the present invention are additives which protect the polymer or polymer mixture against damaging environmental influences.

Examples are primary and secondary antioxidants, hindered amine light stabilizers, UV absorbers, hydrolysis inhibitors, quenchers and flame retardants. If the TPU of the invention is subjected to thermal oxidative damage during use, antioxidants can be added. Preference is given to using phenolic antioxidants. Preference is given to phenolic antioxidants whose molecular weight is greater than 700 g/mol. An example of a preferred phenolic antioxidant is pentaerythrityl tetrakis(3-(3,5-bis(1,1-dimethylethyl)-4-hydroxyphenyl)propionate) (Irganox® 1010), The phenolic antioxidants are generally used in concentrations of from 0.1 to 5% by weight, preferably from 0.1 to 2% by weight, in particular from 0.5 to 1.5% by weight, in each case based on the total weight of the TPU.

The TPUs can be additionally stabilized by means of a UV absorber. UV absorbers are molecules which absorb high-energy UV light and dissipate the energy. UV absorbers which can be used include, for example, the group of cinnamic esters, diphenylcyanoacrylates, formamidines, benzylidenemalonates, diarylbutadienes, triazines and benzotriazoles. In a preferred embodiment, the UV absorbers have a number average molecular weight of greater than 300 g/mol, in particular greater than 390 g/mol. Furthermore, the preferred UV absorbers have a molecular weight of not more than 5000 g/mol, particularly preferably not more than 2000 g/mol. The group of benzotriazoles is particularly useful as UV absorber, Examples of particularly useful benzotriazoles are Tinuvin® 213, Tinuvin® 328, Tinuvin® 571 and Tinuvin® 384 and Eversorb 82. The UV absorbers are preferably added in amounts of form 0.01 to 5% by weight, based on the total mass of TPU, particularly preferably from 0.1 to 2.0% by weight, in particular from 0.2 to 0.5% by weight, in each case based on the total weight of the TPU.

In one embodiment, a hindered amine light stabilizer (HALS) can be added to the polymer, preferably in addition to the antioxidant and the UV absorber. The activity of HALS compounds is based on their ability to form nitroxyl radicals which interfere in the mechanism of the oxidation of polymers. HALSs are highly efficient UV stabilizers for most polymers. HALS compounds are generally known and commercially available. Hindered amine light stabilizers used are preferably hindered amine light stabilizers in which the number average molecular weight is greater than 500 g/mol. Furthermore, the molecular weight of the preferred HALS compounds should preferably be not more than 10 000 g/mol, particularly preferably not more than 5000 g/mol. Particularly preferred hindered amine light stabilizers are bis(1,2,2,6,6-pentamethylpiperidyl) sebacate (Tinuvin® 765, Ciba Spezialitätenchemie AG) and, the condensation product of 1-hydroxyethyl-2,2,6,6-tetramethyl-4-hydroxypiperidine and succinic acid (Tinuvin® 622). Very particular preference is given to the condensation product of 1-hydroxyethyl-2,2,6,6-tetramethyl-4-hydroxypiperidine and succinic acid (Tinuvin® 622) when the titanium content of the product is <150 ppm, preferably <50 ppm particularly preferably <10 ppm. HALS compounds are preferably used in a concentration of form 0.01 to 5% by weight, particularly preferably from 0.1 to 1% by weight, in particular from 0.15 to 0.3% by weight, in each case based on the total weight of the TPU. A particularly preferred UV stabilization comprises a mixture of a phenolic stabilizer, a benzotriazole and an HALS compound in the above-described preferred amounts.

All molecular weights mentioned in the present text have the units [g/mol].

To set the hardness of the TPUs, the molar ratios of the formative components (b) and (c) can be varied within a relatively wide range. Molar ratios of component (b) to total chain extenders (c) to be used of from 10:1 to 1:12, in particular from 1:1 to 1:4, have been found to be useful, with the hardness of the TPUs increasing with increasing content of (c).

The reaction can be carried out at customary indexes, preferably at an index of from 950 to 1050, particularly preferably at an index in the range from 970 to 1010, in particular from 980 to 995. The index is defined as the molar ratio of the total isocyanate groups of the component (a) used in the reaction to the isocyanate-reactive groups, i.e. the active hydrogens, of the components (b) and (c). At an index of 1000, there is one active hydrogen atom, i.e. one isocyanate-reactive function, of the components (b) and (c) per isocyanate group of the component (a). At indexes above 1000, there are more isocyanate groups than OH groups present. The production of the TPUs can be carried out by known methods either continuously, for example by means of reaction extruders or the belt process by the one-shot or the prepolymer process, or discontinuously by the known prepolymer process. In these processes, the components (a), (b) and, if appropriate, (c), (d) and/or (e) which are reacted can be mixed with one another either in succession or simultaneously, with the reaction commencing immediately. In the extruder process, the formative components (a), (b) and, if appropriate, (c), (d) and/or (e) are introduced individually or as a mixture into the extruder, reacted at, for example, temperatures of from 100° C. to 280° C., preferably from 140° C. to 250° C., and the TPU obtained is extruded, cooled and pelletized,

In one embodiment, TPUs are preferably obtainable by reacting (a) isocyanates with (b1) polyester diols having a melting point of greater than 150° C. (b2) polyether diols and/or polyester diols in each case having a melting point of less than 150° C. and a molecular weight of from 501 to 8000 g/mol and, if appropriate, (c) dials having a molecular weight of from 62 g/mol to 500 g/mol. Particular preference is given to thermoplastic polyurethanes in which the molar ratio of the dials (c) having a molecular weight of from 62 g/mol to 500 g/mol to the component (b2) is less than 0.2, particularly preferably from 0.1 to 0.01. Particular preference is given to thermoplastic polyurethanes in which the polyester dials (b1), which preferably have a molecular weight of from 1000 g/mol to 5000 g/mol.

For the purposes of the present text, the expression “melting point” refers to the maximum of the melting peak of a heating curve measured using a commercial DSC instrument (e.g. DSC 7/from Perkin-Elmer).

The molecular weights reported in the present text are the number average molecular weights in [g/mol].

The thermoplastic polyurethanes described above can be prepared by reacting a, preferably high molecular weight, preferably partially crystalline, thermoplastic polyester with a diol (c) in a first step (I) and subsequently, in a further reaction (II), reacting the reaction product from (I) comprising (b1) polyester diol having a melting point of greater than 150° C. and, if appropriate, (c) diol together with (b2) polyether diols and/or polyester diols in each case having a melting point of less than 150° C. and a molecular weight of from 501 to 8000 g/mol and, if appropriate, further (c) dials having a molecular weight of from 62 to 500 g/mol with (a) isocyanate, if appropriate in the presence of (d) catalysts and/or (e) auxiliaries.

The molar ratio of the diols (c) having a molecular weight of from 62 g/mol to 500 g/mol to the component (b2) in the reaction (II) is preferably less than 0.2, preferably from 0.1 to 0.01.

While the hard phases are made available for the end product in step (I) by means of the polyester used in step (I), the use of the component (b2) in step (II) results in formation of the soft phases. Polyesters having a pronounced, readily crystallizing hard phase structure are melted, in a reaction extruder, and firstly degraded by reaction with a low molecular weight dial to form shorter polyesters having free hydroxyl end groups. Here, the original high crystallization tendency of the polyester is retained and can subsequently be utilized in a rapidly occurring reaction to obtain TPUs having the advantageous properties such as high tensile strength, low abrasion values and, because of the high and narrow melting range, high heat distortion resistances and low compression sets. Thus, in the one process, preferably high molecular weight, partially crystalline, thermoplastic polyesters are degraded in a short reaction time by reaction with low molecular weight diols (c) under suitable conditions to give rapidly crystallizing polyester diols (b1) which in turn are then incorporated into high molecular weight polymer chains together with other polyester diols and/or polyether diols and diisocyanates.

Here, the thermoplastic polyester used, i.e. before the reaction (I) with the dial (c), preferably has a molecular weight of from 15 000 g/mol to 40 000 g/mol and preferably has a melting point of greater than 160° C., particularly preferably from 170° C. to 260° C.

As starting material, i.e. as polyester, which is reacted in step (I), preferably in the molten state, particularly preferably at a temperature of from 230° C. to 280° C. for a time of preferably from 0.1 min to 4 min, particularly preferably from 0.3 min to 1 min, with the diol(s) (c), it is possible to use generally known, preferably high molecular weight, preferably partially crystalline, thermoplastic polyesters, for example in pelletized form. Suitable polyesters are based, for example, on aliphatic, cycloaliphatic, araliphatic and/or aromatic dicarboxylic acids, for example lactic acid and/or terephthalic acid, and aliphatic, cycloaliphatic, araliphatic and/or aromatic dialcohols, for example 1,2-ethanediol, 1,4-butanediol and/or 1,6-hexanediol.

Particularly preferred polyesters are: poly-L-lactic acid and/or polyalkylene terephthalate, for example polyethylene terephthalate, polypropylene terephthalate, polybutylene terephthalate, in particular polybutylene terephthalate.

The thermoplastic polyester can be melted at a temperature of from 180° C. to 270° C. The reaction (I) with the diol (c) is preferably carried out at a temperature of from 230° C. to 280° C., preferably from 240° C. to 280° C.

As diol (c) for reaction with the thermoplastic polyester in step (I) and if appropriate in step (II), it is possible to use generally known dials having a molecular weight of from 62 to 500 g/mol, e.g. ethylene glycol, 1,3-propanediol, 1,4-butanediol, 1,5-pentanediol, 1,6-hexanediol, heptanediol, octanediol, preferably 1,4-butanediol and/or 1,2-ethanediol.

The weight ratio of the thermoplastic polyester to the diol (c) in step (I) is usually from 100:1.0 to 100:10, preferably from 100:1.5 to 100:8.0.

The reaction of the thermoplastic polyester with the dial (c) in reaction step (I) is preferably carried out in the presence of catalysts. Preference is given to using catalysts based on metals for this reaction. The reaction in step (I) is preferably carried out in the presence of from 0.1 to 2% by weight of catalysts, based on the weight of the diol (c). The reaction in the presence of such catalysts is advantageous in order to enable the reaction to be carried out in the short residence time available in the reactor, for example a reaction extruder.

Possible catalysts for this reaction step (I) are, for example: tetrabutyl orthotitanate and/or tin(II) dioctoate, preferably tin dioctoate,

The polyester dial (b1) as reaction product from (I) preferably has a molecular weight of from 1000 g/mol to 5000 g/mol. The melting point of the polyester dial as reaction product from (I) is preferably from 150° C. to 260° C., in particular from 165° C. to 245° C., i.e. the reaction product of the thermoplastic polyester with the diol (c) in step (I) comprises compounds which have the melting point mentioned and are used in the subsequent step (II).

In the reaction of the thermoplastic polyester with the diol (c) in step (I), the polymer chain of the polyester is cleaved by transesterification by means of the diol (c). The reaction product of the thermoplastic polyester therefore has free hydroxyl end groups and is preferably processed further in the further step (II) to give the actual product, viz. the TPU.

The reaction of the reaction product from step (I) in step (II) is preferably carried out by addition of a a) isocyanate (a) and (b2) polyether dials and/or polyester dials in each case having a melting point of less than 150° C. and a molecular weight of from 501 to 8000 g/mol and, if appropriate, further diols (c) having a molecular weight of from 62 to 500, (d) one or more catalysts and/or (e) auxiliaries to the reaction product from (I). In accordance with the present disclosure, at least one of the catalysts is a pyridine derivative, such as 4-morpholinopyridine. The reaction of the reaction product with the isocyanate occurs via the hydroxyl end groups formed in step (I). The reaction in step (II) is preferably carried out at a temperature of from 190° C. to 250° C. for a time of preferably from 0.5 to 5 min, particularly preferably from 0.5 to 2 min, preferably in a reaction extruder, particularly preferably in the same reaction extruder in which step (I) has also been carried out. For example, the reaction of step (I) can be carried out in the first barrel section of a customary reaction extruder and the corresponding reaction of step (II) can be carried out at a later point, i.e. later barrel sections, after addition of the components (a) and (b2). For example, the first 30-50% of the length of the reaction extruder can be used for step (I) and the remaining 50-70% can be used for step (II).

The reaction in step (II) is preferably carried out at an excess of isocyanate groups over the groups which are reactive toward isocyanates. The ratio of isocyanate groups to hydroxyl groups in the reaction (II) is preferably from 1:1 to 1.2:1, particularly preferably from 1.02:1 to 1.2:1.

The preferred process is preferably carried out by metering at least one thermoplastic polyester, e.g. polybutylene terephthalate, into the first barrel section of a reaction extruder and melting it at temperatures of preferably from 180° C. to 270° C., preferably from 240° C. to 270° C., adding a diol (c), e.g. butanediol, and preferably a trans-esterification catalyst in a subsequent barrel section, degrading the polyester by reaction with the diol (c) at temperatures of from 240° C. to 280° C. to form polyester oligomers having hydroxyl end groups and molecular weights of from 1000 to 5000 g/mol, adding isocyanate (a) and (b2) compounds which are reactive toward isocyanates and have a molecular weight of from 501 to 8000 g/mol and, if appropriate, (c) diols having a molecular weight of from 62 to 500, (d) catalysts and/or (e) auxiliaries in a subsequent barrel section and subsequently carrying out the formation of the preferred thermoplastic polyurethanes at temperatures of from 190° C. to 250° C.

In step (II), preference is given to feeding in no diols (c) having a molecular weight of from 62 to 500 apart from the diols (c) present in the reaction product from (I).

The reaction extruder preferably has neutral and/or backward-transporting kneading blocks and back-transporting elements, preferably screw mixing elements, toothed disks and/or toothed mixing elements in combination with back-transporting elements, in the region in which the thermoplastic polyester is melted and also in the region in which the thermoplastic polyester is reacted with the dial.

After the reaction extruder, the melt is usually conveyed by means of a gear pump to underwater pelletization and pelletized.

The thermoplastic polyurethanes can have a hardness of from Shore 45A to Shore 78D, particularly preferably from 50A to 75D.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A process for producing a thermoplastic polyurethane comprising:
reacting together at least one organic diisocyanate with at least polyhydroxyl compound having a molecular weight of greater than about 400 and with at least one chain extender, the reaction occurring in the presence of a catalyst, the catalyst comprising a pyridine derivative, the pyridine derivative comprising 4-morpholinopyridine.

2. A process as defined in claim 1, wherein the reaction is carried out at temperature of from about 60° C. to about 250° C.

3. A process as defined in claim 1, wherein the at least one polyhydroxyl compound has a molecular weight of from about 500 to about 11,500.

4. A process as defined in claim 3, wherein the polyhydroxyl compound comprises a polyoxyalkylene polyether polyol.

5. A process as defined in claim 3, wherein the polyhydroxyl compound comprises a polyester polyol.

6. A process as defined in claim 1, wherein the at least one chain extender comprises 1,4-butanediol.

7. A process as defined in claim 1, wherein all the polyhydroxyl compounds are in a molar ratio to all of the chain extenders in a range of from about 1:1 to about 1:8.

8. A process as defined in claim 1, further comprising the step of adding a flame retardant to the formed thermoplastic polyurethane.

9. A process as defined in claim 1, further comprising the step of adding a light stabilizer to the formed thermoplastic polyurethane.

10. A process as defined in claim 1, wherein the formed thermoplastic polyurethane has a shore A hardness of from about 70 to about 94.

11. A process as defined in claim 1, further comprising the step of crosslinking the thermoplastic polyurethane.

12. A process as defined in claim 11, wherein the process further includes a step of combining the formed thermoplastic polyurethane with a second isocyanate compound for cross linking the thermoplastic polyurethane.

13. A process as defined in claim 1, wherein the thermoplastic polyurethane is polyester-based.

14. A process as defined in claim 1, wherein the thermoplastic polyurethane is polyether-based.

15. A process as defined in claim 1, wherein the organic diisocyanate comprises an aliphatic diisocyanate and wherein the formed thermoplastic polyurethane is aliphatic-based.

16. A process as defined in claim 1, wherein the at least one chain extender has a molecular weight of from about 50 to about 450.

17. A thermoplastic polyurethane elastomer containing 4-morpholinopyridine.

18. A thermoplastic polyurethane elastomer as defined in claim 17, wherein the thermoplastic polyurethane elastomer has a Shore A hardness of from about 70 to about 94.

19. A composition containing the thermoplastic polyurethane elastomer as defined in claim 17 combined with a hindered amine light stabilizer.

20. A composition as defined in claim 19, further containing a benzotriazole.
